(19) United States
(12) Patent Application Publication
(10) Pub. No.: US 2008/0088612 A1
(43) Pub. Date: Apr. 17, 2008

(54) METHOD FOR CORRECTING IMAGE DISTORTION AND APPARATUS THEREOF

(75) Inventors: In-Jae Yeo, Yongin-si (KR); Sang-Kyeong Yun, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/870,320

(22) Filed: Oct. 10, 2007

(30) Foreign Application Priority Data
Oct. 11, 2006 (KR) 1020060099030

(51) Int. Cl. G09G 5/00

(52) U.S. Cl. 345/204

(57) ABSTRACT

The present invention relates to an image processing method and an apparatus thereof, more specifically to a method for correcting image distortion and an apparatus thereof. When a display apparatus using a diffractive optical modulator corrects the distortion of an image in accordance with an embodiment of the present invention, a contracted image coordinate value is computed by multiplying an original image coordinate value by a contraction factor; the computed contracted image coordinate value is compared with a converted image coordinate value; the contracted image coordinate value corresponding to the converted image coordinate value is extracted; a gradation value of the converted image coordinate value is computed from a gradation value of the contracted image coordinate value; and the diffractive optical modulator corresponding to the computed gradation value of the converted image coordinate value is operated.

This application claims the benefit of Korean Patent Application No. 10-2006-0099030, filed on Oct. 11, 2006, in the Korean Intellectual Property Office, the disclosure of which is incorporated herein in its entirety by reference.

### BACKGROUND OF THE INVENTION

1. Field of the Invention

The present invention relates to an image processing method and an apparatus thereof, more specifically to an image processing method for correcting image distortion and an apparatus thereof.

2. Background Art

Today's development of display technologies has increased the demands for realizing large-sized images. Most of the large-sized image display apparatuses (e.g. a projector) are currently using liquid crystal as an optical switch. Liquid crystal projectors are more popular than conventional CRT projectors, due to their compact sizes, low prices and simpler optical systems. However, when light emitted from a light source passes through a liquid crystal film and is displayed on a screen, a lot of optical losses occur in the liquid crystal projector. Accordingly, a method for reducing the optical loss has been developed to display an image more brightly by employing a micro-machine such as a spatial optical modulator using reflection.

The micro-machine refers to a machine that is too small for a naked eye to identify. This micro-machine can be referred to as a micro electro mechanical system (MEMS) or a micro electro mechanical device, which is created by applying semiconductor manufacturing technologies. The MEMS is applied for a lot of information apparatus elements, such as a magnetic head and an optical head, by using a micro optical device and an extreme device. The MEMS is also applied in the field of biomedicine and semiconductor manufacturing processes by using a variety of microfluidics. The micro-machine can be grouped into a micro sensor, functioning as a sensing device, a micro actuator, functioning as a driving device, and a miniature machine, transferring other types of energy.

The MEMS, which is one of various application fields, is being used for optical science. If the MEMS technology is used, not only optical devices having a smaller size than 1 mm can be manufactured but also micro optical systems can be realized by using the optical devices.

Micro optical elements, such as optical modulators and micro lenses, which belong to the micro optical system, are employed and applied in communication apparatuses, displays and recording apparatuses, owing to their quick response, little loss, and easy integration and digital capabilities.

A spatial optical modulator (SOM), which is used for a scanning display apparatus, a type of display, is configured to include a driving integrated circuit and a plurality of micro-mirrors. At least one micro-mirror is used, to thereby represent a pixel of a projected image.

At this time, in order to represent light intensity of one pixel, the micro-mirror changes the quantity of modulated light by adjusting its displacement according to a driving voltage supplied from a driver IC, which generates a driving voltage having particular relationship with an input signal.

FIG. 1A through FIG. 1D illustrate the structure of a conventional display apparatus and a distorted image projected to a screen. Referring to FIG. 1A, the conventional display apparatus can include a light source 110, a lighting optical system 120, a spatial optical modulator 130, a driver IC 140, a relay optical system 150, a scanner 160, a projection optical system 170 and an image controlling circuit 180.

The light source 110 emits a beam of light in order that an image can be projected to a screen 190. Since the lighting optical system 120 is placed between the light source 110 and the spatial optical modulator 130, the light emitted from the light source 110 can be concentrated on the spatial optical modulator 130 by reflecting the light at a predetermined angle.

The spatial optical modulator 130 outputs modulated light, modulated with the light emitted from the light source 110, according to a driving voltage provided from the driver IC 140. The number of a plurality of micro-mirrors, equipped in the spatial optical modulator 130, can be identical to that of pixels constituting a vertical or horizontal scanning line.

The driver IC 140 supplies to the spatial optical modulator 130 a driving voltage, which changes the brightness of modulated light outputted according to an image controlling signal provided from the image controlling circuit 180.

The relay optical system 150 allows modulated light outputted from the spatial optical modulator 130 to be transferred to the scanner 160. The scanner 160 reflects modulated light incident from the spatial optical modulator 130 at a predetermined angle and projects the light to the screen 190.

The projection optical system 170 includes a projection lens by which the modulated light, reflected by the scanner 160, is projected to the screen 190.

The image controlling circuit 180 supplies an image controlling signal, a scanner controlling signal and a light source signal to the driver IC 140, the scanner 160 and the light source 110, respectively. One frame image is allowed to be displayed on the screen 190 by the image controlling signal, the scanner controlling signal and the light source signal, linked with one another.

Referring to FIG. 1B, in case that the modulated light reflected from the scanner 160 is projected to the screen 190, the path difference at a center part and opposite side parts of the screen 190 occurs between the scanner 160 and the screen 190, causing an image to distort. In other words, referring to FIG. 1C, in the case of being viewed from a side part, the modulated light reflected from the scanner 160 is regularly projected to the screen 190. However, referring to FIG. 1D, throughout the screen 190, the modulated light is projected longer in the opposite side parts, resulting in an overall distortion of the image.

### SUMMARY OF THE INVENTION

The present invention provides an image distortion correcting method and an apparatus thereof that can project an image having no distortion regardless of a distance between a screen and a display apparatus by correcting the distortion of the image.

The present invention also provides an image distortion correcting method and an apparatus thereof that can minimize image distortion while using the least memory resources.

Other problems that the present invention solves will become more apparent through the following description.

According to an aspect of the present invention, there can be provided a method by a display apparatus for correcting a distortion of an image by use of a diffractive optical modulator, the method including steps of computing a contracted image coordinate value by multiplying an original image coordinate value by a contraction factor; comparing the computed contracted image coordinate value with a converted image coordinate value; extracting the contracted image coordinate value corresponding to the converted image coordinate value; computing a gradation value of the converted image coordinate value from a gradation value of the contracted image coordinate value; and operating the diffractive optical modulator in accordance with the computed gradation value of the converted image coordinate value.

According to another aspect of the present invention, there can be provided a display apparatus, including an image distortion removing unit, computing a contracted image coordinate value by multiplying an original image coordinate by a contraction factor, comparing the computed contracted image coordinate value with a converted image coordinate value, extracting the contracted image coordinate value corresponding to the converted image coordinate value, and computing a gradation value of the converted image coordinate value from a gradation value of the contracted image coordinate value; an image processing unit, generating an image controlling signal corresponding to the gradation value of the converted image coordinate value, computed in the image distortion removing unit; a driver IC, receiving the image controlling signal from the image processing unit and generating a driving voltage driving a diffractive optical modulator; and the diffractive optical modulator, receiving the driving voltage from the driver IC and reflecting and refracting light incident from a light source.

Here, if the converted image coordinate value is matched to 3 contracted image coordinate values, the gradation value of the converted image coordinate value can be computed by a following

L(Y)=l(Y−1)Rₚᵣₑ+l(Y)R_{body}+l(Y+1)Rₚₒₛₜ,

whereas L(Y) refers to the gradation of an Y^{th} coordinate value of a converted image; 1(Y) refers to the gradation of an Y^{th} coordinate value of a contracted image; Rₚᵣₑ refers to a rate of a (Y−1) th coordinate value of the contracted image, mapped to the Y^{th} coordinate value of the converted image; R_{body} refers to a rate of a (Y+1)^{th} coordinate value of the contracted image, mapped to the Y^{th} coordinate value of the converted image; and Rₚₒₛₜ refers to a rate of the (Y+1)^{th} coordinate value of the contracted image, mapped to the Y^{th} coordinate value of the converted image.

Here, the summation of the Rₚᵣₑ, the R_{body} and the Rₚₒₛₜ can be equal to 1.

Also, the diffractive optical modulator can include an upper reflective layer, being placed on a center part of a structural layer and reflecting and refracting the incident light; a piezoelectric driving element, being placed on the structural layer and allowing the center part of the structural layer to move upwardly and downwardly; and an optical reflective layer, being spaced away from the upper reflective layer and reflecting and refracting the incident light.

### BRIEF DESCRIPTION OF THE DRAWINGS

These and other features, aspects and advantages of the present invention will become better understood with regard to the following description, appended claims and accompanying drawings where:

FIG. 1A through FIG. 1D illustrate the structure of a conventional display apparatus;

FIG. 2A is a perspective view showing a type of a diffractive optical modulator module using a piezoelectric element applicable to an embodiment of the present invention;

FIG. 2B is a perspective view showing another type of a diffractive optical modulator module using a piezoelectric element applicable to an embodiment of the present invention;

FIG. 2C is a plan view showing a diffractive optical modulator array applicable to an embodiment of the present invention;

FIG. 2D is a schematic view showing a screen on which an image is generated by a diffractive optical modulator array applicable to an embodiment of the present invention;

FIG. 3 illustrates a structure of a display apparatus in accordance with an embodiment of the present invention;

FIG. 4 and FIG. 5 are flow charts illustrating an image processing operation for removing image distortion in accordance with an embodiment of the present invention;

FIG. 6 is a matching view of a pixel for the correction of a distorted image in accordance with an embodiment of the present invention;

FIG. 7 is a flow chart illustrating a process of correcting a distorted image in accordance with an embodiment of the present invention; and

FIG. 8 is a data processing view illustrating a process of correcting a distorted image in accordance with an embodiment of the present invention.

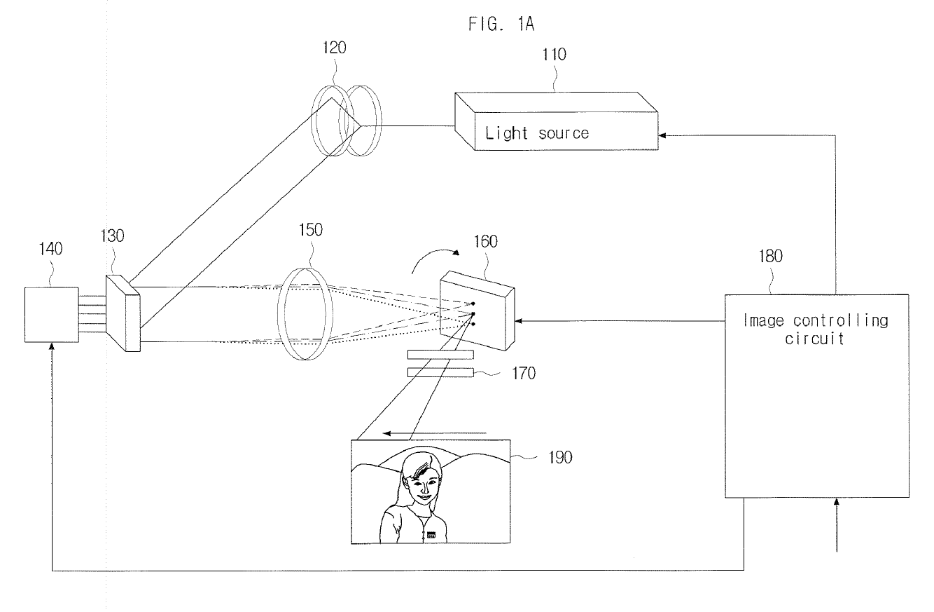

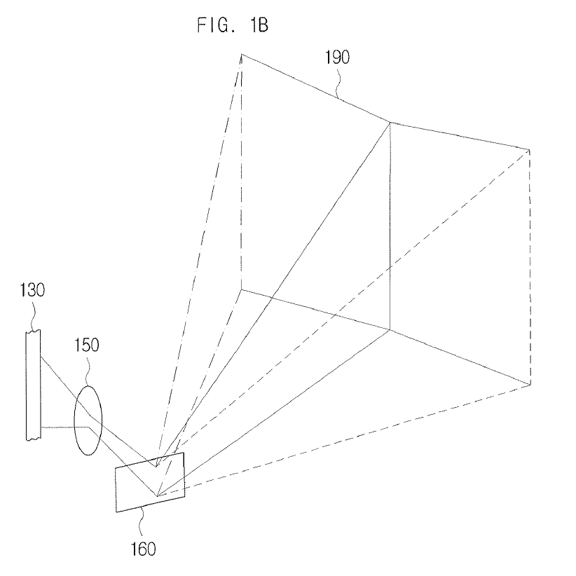

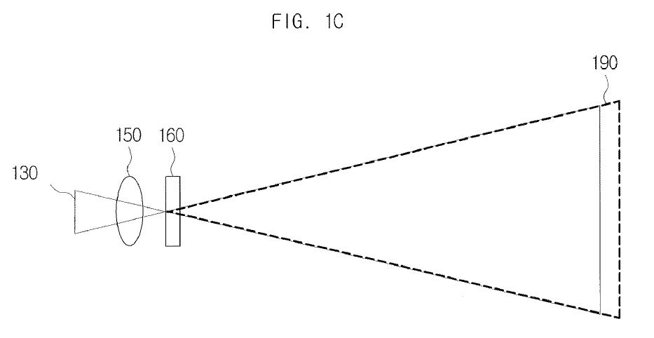

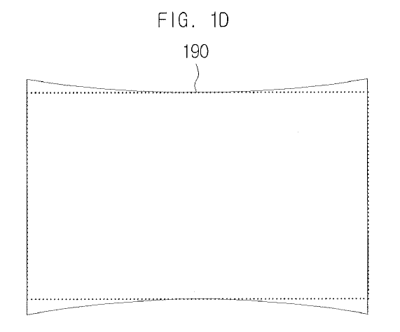

### DESCRIPTION OF THE EMBODIMENTS

Hereinafter, some embodiments of a method for correcting image distortion and an apparatus thereof in accordance with the present invention will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain technology is determined to evade the point of the present invention, the pertinent detailed description will be omitted. Before the detailed description related to the embodiment of the present invention, a spatial optical modulator, among the MEMS package applied by the present invention, will be firstly described.

The spatial optical modulator is mainly divided into a direct type, which directly controls the on/off state of light, and an indirect type, which uses reflection and diffraction. The indirect type can be further divided into an electrostatic type and a piezoelectric type. Here, the spatial optical modulator is applicable to the present invention regardless of the operation type.

An electrostatic type grating optical modulator includes a plurality of constantly spaced reflective ribbons having reflective surfaces and suspended above an upper part of the substrate, the spaced distances of the reflective ribbons being adjustable.

First, an insulation layer is deposited onto a silicon substrate, followed by depositions of a silicon dioxide film and a silicon nitride film. Here, the silicon nitride film is patterned with the ribbons, and some portions of the silicon dioxide film are etched such that the ribbons can be maintained by a nitride frame on an oxide spacer layer. The ribbon and the oxide spacer of the spatial optical modulator are designed to have a thickness of λ₀/4 in order to modulate a light beam having a single wavelength λ₀.

The grating amplitude, of the modulator limited to the vertical distance d between the reflective surfaces of the ribbons and the reflective surface of the substrate, is controlled by supplying a voltage between the ribbons (the reflective surface of the ribbon, which acts as a first electrode) and the substrate (the conductive film at the bottom portion of the substrate, which acts as a second electrode).

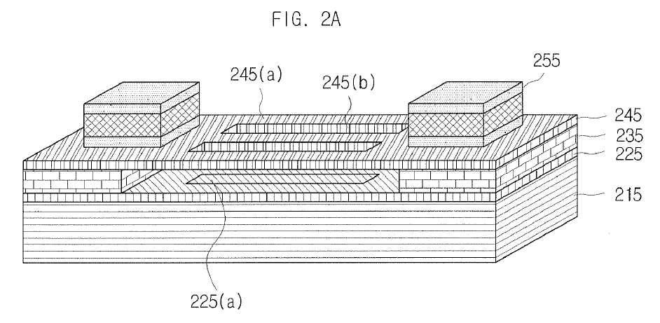

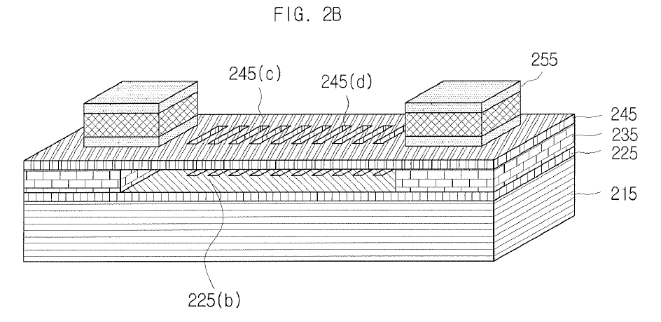

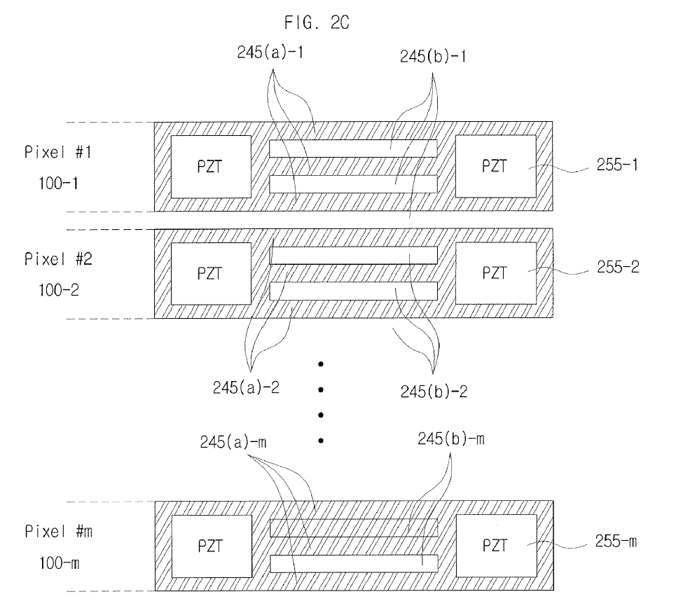

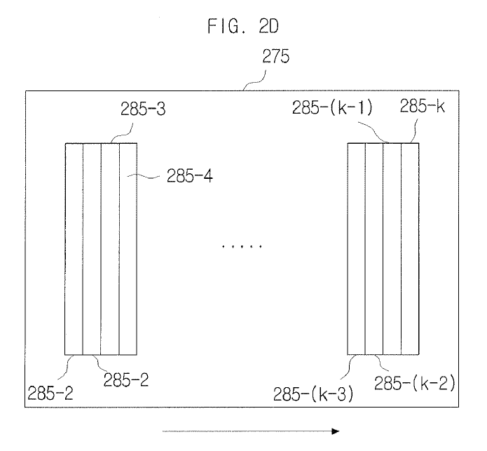

FIG. 2A is a perspective view showing a type of a diffractive optical modulator module using a piezoelectric element applicable to an embodiment of the present invention, and FIG. 2B is a perspective view showing another type of a diffractive optical modulator module using a piezoelectric element applicable to an embodiment of the present invention. Referring to FIG. 2A and FIG. 2B, a spatial optical modulator include a substrate 215, an insulation layer 225, a sacrificial layer 235, a ribbon structure 245 and a piezoelectric element 255.

The substrate 215 is a commonly used semiconductor substrate, and the insulation layer 225 is deposited as an etch stop layer. The insulation layer 225 is formed from a material with a high selectivity to the etchant (an etching gas or an etching solution) that etches the material used as the sacrificial layer 235. Here, a lower reflective layer 225(a) or 225(b) can be formed on the insulation layer 125 to reflect incident beams of light.

The sacrificial layer 235 supports the ribbon structure 245 at opposite sides such that the ribbon structure 245 can be spaced by a constant gap from the insulation layer 225, and forms a space in the center part.

The ribbon structure 245, as described above, creates diffraction and interference in the incident light to perform optical modulation of signals. The form of the ribbon structure 245, as described above, can be configured in a plurality of ribbon shapes in the electrostatic type, or can include a plurality of open holes in the center portion of the ribbons in the piezoelectric type. Also, the piezoelectric element 255 controls the ribbon structure 245 to move upwardly and downwardly according to upward and downward, or leftward and rightward contraction or expansion levels generated by the difference in voltage between the upper and lower electrodes. Here, the lower reflective layer 225(a) or 225(b) is formed in correspondence with the holes 245(b) or 245(d) formed in the ribbon structure 245.

For example, in case that the wavelength of a beam of light is λ, when there is no power supplied or when there is a predetermined amount of power supplied, the gap between an upper reflective layer 245(a) or 245(c), formed on the ribbon structure 245, and the insulation layer 225, formed with the lower reflective layer 225(a) or 225(b), is equal to nλ/2, n being a natural number. Accordingly, in the case of a 0^{th}-order diffracted (reflected) beam of light, the overall path length difference between the light reflected by the upper reflective layer 245(a) or 245(c) formed on the ribbon structure 245 and the light reflected by the insulation layer 225 is equal to nλ, so that constructive interference occurs and the diffracted light renders its maximum luminance. In the case of a +1^{st} or −1^{st} order diffracted light, however, the luminance of the light is at its minimum value due to destructive interference.

When a predetermined amount of power, which is different from the supplied power mentioned above, is supplied to the piezoelectric elements 255, the gap between the upper reflective layer 245(a) or 245(c) formed on the ribbon structure 245 and the insulation layer 225, formed with the lower reflective layer 225(a) or 225(b), becomes (2n+1)λ/4, n being a natural number. Accordingly, in the case of a 0^{th}-order diffracted (reflected) beam of light, the overall path length difference between the light reflected by the upper reflective layer 245(a) or 245(c) formed on the ribbon structure 245 and the light reflected by the insulation layer 225 is equal to (2n+1)λ/2, so that destructive interference occurs, and the diffracted light renders its minimum luminance. In the case of the +1^{st} or −1^{st} order diffracted light, however, the luminance of the light is at its maximum value due to constructive interference. As a result of such interference, the spatial optical modulator can load signals on the beams of light by adjusting the quantity of the reflected or diffracted light.

Although the foregoing describes the cases in which the gap between the ribbon structure 245 and the insulation layer 225, formed with the lower reflective layer 225(a) or 225(b), is nλ/2 or (2n+1)λ/4, it is obvious that a variety of embodiments, which are able to operate with a gap adjusting the intensity of interference by diffraction and reflection of the incident light, can be applied to the present invention.

The below description will focus on a spatial optical modulator illustrated in FIG. 2A and described above.

Referring to FIG. 2C, the spatial optical modulator is configured to include m micro-mirrors 100-1, 100-2, . . . , and 100-m, each of which corresponds to a first pixel (pixel #1), a second pixel (pixel #2), . . . , and an m^{th} pixel (pixel #m), respectively, m being a natural number. The spatial optical modulator deals with image information with respect to 1-dimensional images of vertical or horizontal scanning lines (which are assumed to consist of m pixels.), while each micro-mirror 100 deals with one pixel among the m pixels constituting the vertical or horizontal scanning line. Thus, the light reflected or diffracted by each micro-mirror is later projected as a 2-dimensional image to a screen by an optical scanning device. For example, in the case of an image having a VGA resolution of 640*480, modulation is performed 640 times for one surface of the optical scanning device for 480 vertical pixels, to thereby generate 1 frame of display per surface of the optical scanning device. Here, the optical scanning device can be a polygon mirror, a rotating bar, or a Galvano mirror, for example.

While the description below of the principle of optical modulation will be described based on the first pixel (pixel #1), the same can be obviously applied to other pixels.

In the present embodiment, it is assumed that the number of holes 245(b)-1 formed in the ribbon structure 245 is two. Because of the two holes 245(b)-1, there are three upper reflective layers 245(a)-1 formed on an upper part of the ribbon structure 245. On the insulation layer 225, two lower reflective layers are formed in correspondence with the two holes 245(b)-1. Also, there is another lower reflective layer formed on the insulation layer 225 in correspondence with the gap between the first pixel (pixel #1) and the second pixel (pixel #2). Thus, per each pixel, the number of the upper reflective layers 240(a)-1 is 3, which is identical to that of the lower reflective layers, and as discussed above with reference to FIG. 2A, it is possible to control the luminance of the modulated light by using the 0^{th}-order diffracted light or ±1^{st}-order diffracted light.

FIG. 2D is a schematic view showing a screen on which an image is generated by a diffractive optical modulator array applicable to an embodiment of the present invention.

Lights reflected and/or diffracted by vertically arranged m micro-mirrors 100-1, 100-2, . . . , and 100-m are reflected by the optical scanning device and then scanned horizontally onto a screen 275, to thereby generate a picture 185-1, 185-2, 185-3, 185-4, . . . , 185-(k-3), 185-(k-2), 185-(k-1), and 185-k. One image frame can be projected in the case of one rotation of the optical scanning device. Here, although the scanning is performed from left to right (the arrow indicating direction), it is apparent that images can be scanned in another direction (e.g. in the opposite direction).

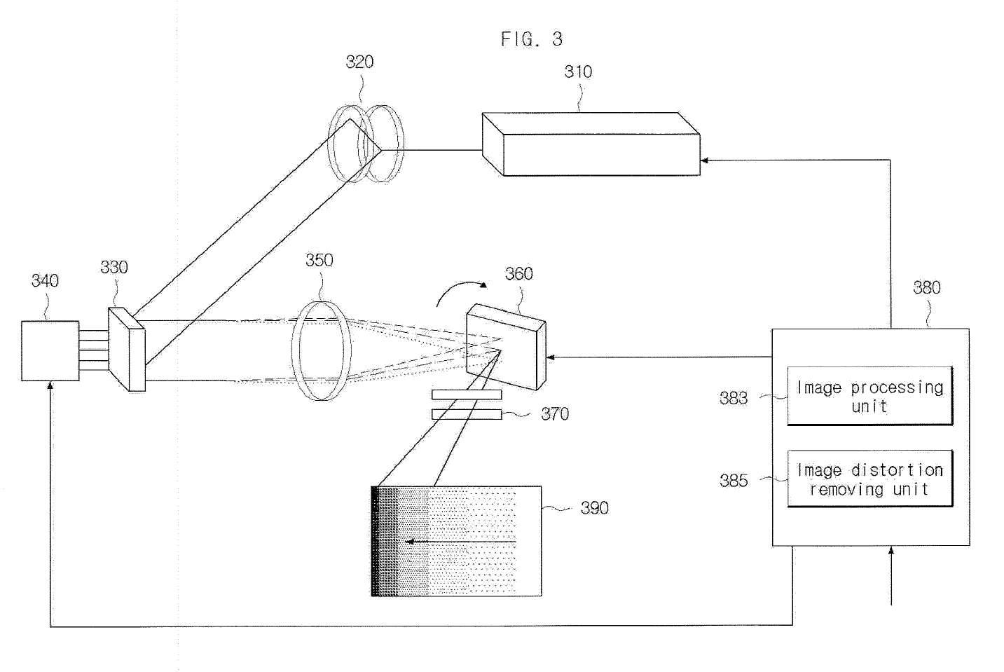

FIG. 3 illustrates a structure of a display apparatus in accordance with an embodiment of the present invention. In accordance with an embodiment of the present invention, the display apparatus can include a light source 310, a lighting optical system 320, a spatial optical modulator 330, a driver IC 340, a relay optical system 350, a scanner 360, a projection optical system 370 and an image controlling circuit 380.

The light source 310 emits a beam of light in order that an image can be projected to a screen 390. The light source 310 can emit white light or any one of red light, green light and blue light, which are 3 primary colors of light. Herein, the light source 310 can employ light amplification by stimulated emission of radiation (LASER), a light-emitting diode (LED) or a laser diode. In the case of emitting the white light, a color dividing unit (not shown) can be provided to divide the white light into the red light, the green light and the blue light.

Since the lighting optical system 320 is placed between the light source 310 and the spatial optical modulator 330, the light emitted from the light source 310 can be concentrated on the optical modulator 330 by reflecting the light at a predetermined angle. In case that color division has been performed by the color dividing unit (not shown), a function allowing the light to be concentrated can be added.

The spatial optical modulator 330 outputs modulated light according to a driving voltage supplied from the driver IC 340, the modulated light referring to the light modulated with the light emitted from the light source 310. Since the spatial optical modulator 330 was previously described in detail with reference to FIG. 2A, the pertinent detailed description will be omitted. The spatial optical modulator 330 is configured to include a plurality of micro-mirrors arranged in a line. The spatial optical modulator 330 deals with a 1-dimensional direct line image corresponding to a vertical or horizontal scanning line in one frame image. In other words, when it comes to the 1-dimensional direct line image, the spatial optical modulator 330 outputs modulated light changed with the brightness by adjusting the displacement of each micro-mirror corresponding to each pixel of the 1-dimensional direct line image according to a supplied driving voltage.

The number of a plurality of micro-mirrors can be identical to that of a pixel constituting a vertical or horizontal scanning line. The modulated light, which is the light applied with image information (i.e. a brightness value of each pixel constituting a vertical or horizontal scanning line) of a vertical or horizontal scanning line to be projected later to the screen 390, can be 0^{th}, +n^{th} or −n^{th} order diffracted (reflected) light, n being a natural number.

The driver IC 340 supplies to the spatial optical modulator 330 a driving voltage changing the brightness of modulated light outputted according to an image controlling signal supplied from the image controlling circuit 380.

The relay optical system 350 allows modulated light outputted from the spatial optical modulator 330 to be transferred to the scanner 360. The relay optical system 350 can include at least one lens. Also, the relay optical system 350 adjusts the magnification, as necessary, to fit the size of the spatial optical modulator 330 and the size of the scanner 360 in order to transfer the modulated light.

The scanner 360 reflects modulated light incident from the spatial optical modulator 330 at a predetermined angle and projects the light to the screen 390. At this time, the predetermined angle is determined by a scanner controlling signal inputted from the image controlling circuit 380. The scanner controlling signal is synchronized with an image controlling signal and rotates the scanner 360 at an angle capable of projecting modulated light to a position of a vertical scanning line (or a horizontal scanning line) on the screen 390 corresponding to the scanner controlling signal. The scanner 360 can be a polygon mirror, a rotating bar, or a Galvano mirror, for example.

The projection optical system 370 includes a projection lens by which the modulated light, reflected by the scanner 360, is projected to the screen 390.

An image processing unit 383 included in the image controlling circuit 380 supplies an image controlling signal, a scanner controlling signal and a light source signal to the driver IC 340, the scanner 360 and the light source 310, respectively. One frame image is allowed to be displayed on the screen 390 by the image controlling signal, the scanner controlling signal and the light source signal, linked with one another. The image processing unit 383, which receives an image signal corresponding to one frame, controls the light source 310, the spatial optical modulator 330 and the scanner 360. The image controlling circuit 380 provides to the driver IC 340 an image controlling signal corresponding to brightness information desired to be displayed for each pixel constituting a frame and adjusts a rotating angle or a rotating speed of the scanner 360 such that the vertical scanning line (or the horizontal scanning line) can be projected to a predetermined position on the screen 390.

An image distortion removing unit 385 included in the image controlling circuit 380 computes a contracted image coordinate value by multiplying an original image coordinate by a contraction factor, compares the computed contracted image coordinate value with a converted image coordinate value and extracts the contracted image coordinate value corresponding to the converted image coordinate value, and computes a gradation value of the converted image coordinate value from a gradation value of the contracted image coordinate value. Here, since the distortion of an image is varied depending on the distance between the screen 390 and the scanner 360, the contraction factor depends on the left and/or right distance of the screen 390. This image distortion removing unit 385 will be described in detail below.

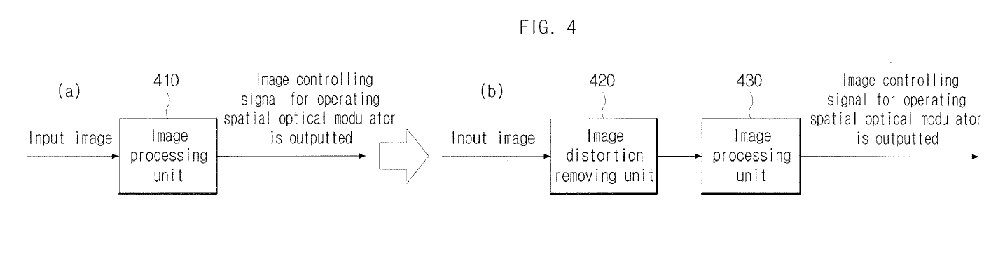

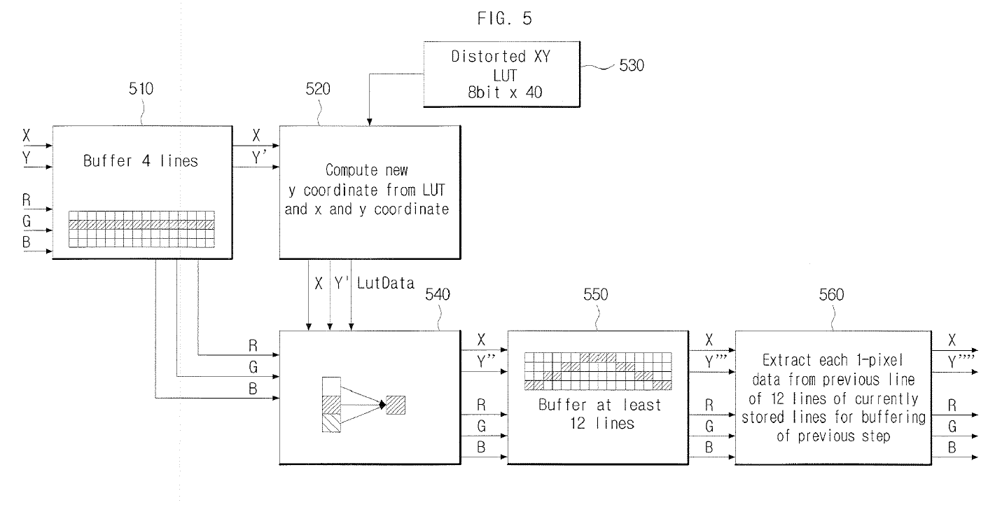

FIG. 4 and FIG. 5 are flow charts illustrating an image processing operation for removing image distortion in accordance with an embodiment of the present invention.

Referring to FIG. 4, in the case of being inputted with image data, an image processing unit 410 in accordance with a related art (a) supplies an image controlling signal, a scanner controlling signal and a light source controlling signal to the driver IC 340, the scanner 360 and the light source 310, respectively. Here, the image controlling signal, which is generated without an additional process for correcting image distortion, is inputted to the image processing unit 410. Then, the image controlling signal for operating the spatial optical modulator is supplied to the driver IC 340.

However, image data in accordance with an embodiment (b) of the present invention passes through the image distortion removing unit 420 and is corrected in order that an image having no distortion can be projected to the screen 390 before transmitted to the image processing unit 430.

In FIG. 5, by referring to a distortion coordinate lookup table (refer to 530) and buffering 4 lines corresponding to the horizontal resolution of original image data (X,Y) (refer to 510), the original image data (X,Y) is multiplied by a contraction factor corresponding to an X axis stored in the distortion coordinate lookup table in order to compute a contracted image coordinate value (X, Y′) (refer to 520). At this time, X refers to a horizontal coordinate, and Y refers to a vertical coordinate. It is assumed that there are 480 pixels vertically. The same goes for the below description. Also, 3 lines of the 4 lines is for reading pertinent image data, and the other line is for extracting data to compute the contracted image coordinate value (X, Y′).

Here, as described above, in the case of projecting modulated light to a screen, since the coordinate of a distorted image is a vertical direction (Y), Y values are corrected. If the projected image is a color image, each of the R, G and B components can be corrected. Then, the contracted image coordinate value (X, Y′) is compared with and matched to a converted image coordinate value (X,Y″) so as to extract the contracted image coordinate value (X, Y′) corresponding to the converted image coordinate value (X,Y″). Here, a gradation value of the converted image coordinate value (X,Y″) is computed from a gradation value of the contracted image coordinate value (X, Y′).

After that, the vertical buffering for 12(or 16) lines is performed (refer to 560). Then, each 1-pixel data is extracted from a previous line of the 12(or 16) lines of currently stored lines for the buffering of a previous step. Here, the number of buffered lines is not limited to 12(or 16). The number can be varied depending on the distortion amount necessary to be corrected. The number of buffered lines is at least one more line (for extracting data for operation) than the number of lines necessary for correction.

Then, an image controlling signal, for operating the spatial optical modulator, corresponding to the finally extracted contracted image coordinate value (X, Y′) is supplied to the drive IC 340. Here, a firstly inputted image is generated by a horizontal scanning line. In case that the modulated light projected from the spatial optical modulator is corresponding to a vertical scanning line, in accordance with an embodiment of the present invention, at least 12 lines can be buffered horizontally (refer to 550).

Accordingly, a minimum resource capable of being buffered can be computed by the formula of horizontal resolution ×20 bytes ×3 bytes. Here, the 20 bytes are the resource for buffering the first 4 lines (refer to 510) in case that 16 lines are buffered, and 3 bytes are the resource for R, G and B components.

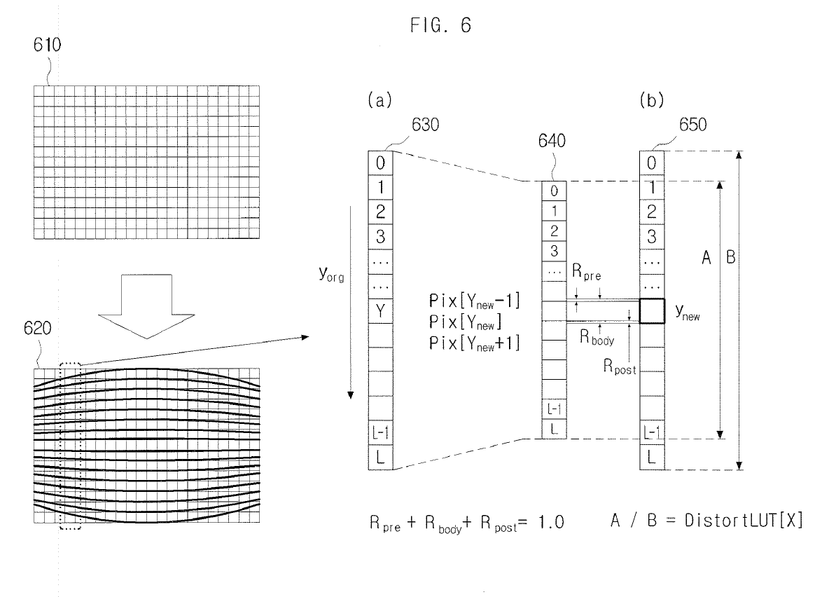

FIG. 6 is a matching view of a pixel for the correction of a distorted image in accordance with an embodiment of the present invention. Referring to FIG. 6, a coordinate value of an image having no distortion (refer to 610) and relationship of matching a contracted image coordinate value to a converted image coordinate value (refer to 620) are illustrated.

In the relationship of matching a contracted image coordinate value to a converted image coordinate value 620, if a part represented by dotted lines is enlarged, the correlation between an original image coordinate value 630, a contracted image coordinate value 640 and a converted image coordinate value 650 is illustrated. The original image coordinate value 630 before correction has the whole length of B, and the contracted image coordinate value 640 applied with a contraction factor has the whole length of A. Here, the contraction factor can be represented as A/B.

Here, the contracted image coordinate value 640 has the same gradation value as the original image coordinate value 630. However, the size of the gradation value is contracted. Accordingly, in case that 3 pixels of the contracted image coordinate value 640 are mapped to one pixel of the converted image coordinate value 650, the gradation of converted image coordinate value 650 can be computed in accordance with their overlapping rate. In other words, L(Y), the gradation of an Y^{th} coordinate value 650 of a converted image, can be computed by the following formula 1.

L(Y)=l(Y−1)Rₚᵣₑ+l(Y)R_{body}+l(Y+1)Rₚₒₛₜ (1)

Here, L(Y) refers to the gradation of an Y^{th} coordinate value of a converted image. l(Y) refers to the gradation of an Y^{th} coordinate value of a contracted image. Rₚᵣₑ refers to a rate of the (Y−1)^{th} coordinate value of the contracted image, mapped to the Y^{th} coordinate value of the converted image. R_{body} refers to a rate of the (Y+1)^{th} coordinate value of the contracted image, mapped to the Y^{th} coordinate value of the converted image. Rₚₒₛₜ refers to a rate of the (Y+1)^{th} coordinate value of the contracted image, mapped to the Y^{th} coordinate value of the converted image. Here, although it is assumed that the (Y−1)^{th}, Y^{th} and (Y+1)^{th} coordinate values of the contracted image are mapped to the Y^{th} coordinate value of the converted image, they can be matched to one another regardless of each character and order. In other words, it can be represented that the (T−1)^{th}, T^{th} and (T+1)^{th} coordinate values of the contracted image are mapped to the Y^{th} coordinate value of the converted image. Since the Rₚᵣₑ, R_{body} and Rₚₒₛ are the rates of mapping the (Y−1)^{th}, Y^{th} and (Y+1)^{th} coordinate values of the contracted image to the Y^{th} coordinate value of the converted image, the following formula 2 is satisfied.

Rₚᵣₑ+R_{body}+Rₚₒₛₜ=1 (2)

Although the above description is based on the assumption that 3 pixels of the contracted image coordinate value 640 are mapped to one pixel of the converted image coordinate value 650, there can be a possibility that 2 pixels of the contracted image coordinate value 640 are mapped to one pixel of the converted image coordinate value 650. In this case, the Rₚᵣₑ or Rₚₒₛₜ can be zero.

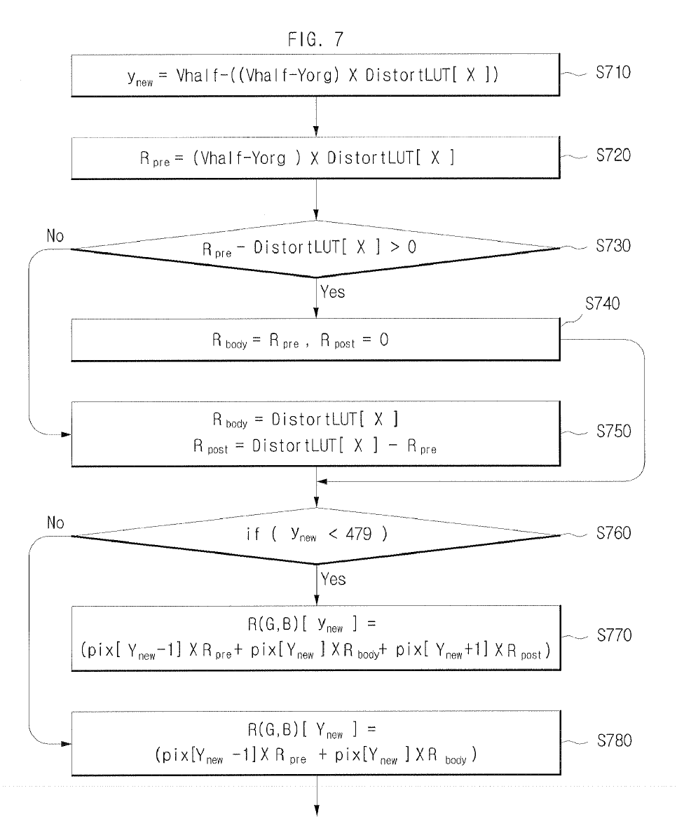

FIG. 7 is a flow chart illustrating a process of correcting a distorted image in accordance with an embodiment of the present invention. In FIG. 7, Yorg refers to a Y coordinate value of a pixel in an original image. Ynew is a Y coordinate value of a converted image after distortion correcting conversion of Yorg. DistortLUT[X] refers to a contraction factor of an X coordinate of Yorg. Rₚᵣₑ refers to a rate of mapping a pixel having a firstly positioned Y coordinate to a pixel of a converted image in case that the number of pixels, having X and Ynew coordinate of an image after converted, including a pixel of a partial mapped original image is 3. R_{body} refers to a rate of mapping a pixel having a secondly positioned Y coordinate to a pixel of a converted image in case that the number of pixels, having X and Ynew coordinate of an image after converted, including a pixel of a partial mapped original image is 3. Rₚₒₛₜ refers to a rate of mapping a pixel having a thirdly positioned Y coordinate to a pixel of a converted image in case that the number of pixels, having X and Ynew coordinate of an image after converted, including a pixel of a partial mapped original image is 3. R(G,B)[Ynew] refers to a gradation value R(G, B) of a pixel having the coordinate (X, Ynew) of the converted image. The R(G,B)[Ynew] can be represented as L(X, Ynew).

In a step represented by S710, Ynew can be computed by the following formula 3.

Ynew=Vhalf−((Vhalf−Yorg)*DistortLUT[X]) (3)

### In a step represented by S720, Ypre can be computed by the following formula 4.

Rpre=(Vhalf−Yorg)*DistortLUT[X] (4)

Typically, in an image coordinate, it is possible that the most upper end part is zero and the lowest part is 479 in the case of 1024×768 or 767. If a center part of an image is set as the original of a vertical direction in order to compute distortion, Yorg is a typical image coordinate system, and Vhalf is an exact half of image vertical resolution. Accordingly, in case that the vertical resolution is 480, the Vhalf becomes 240.

In a step represented by S730, the Rpre is compared with the DistortLUT[X]. In case that the Rpre is larger than the DistortLUT[X], the following formula 5 is satisfied in a step represented by S740.

Rbody=Rpre, Rpost=0 (5)

If the Rpre is smaller than the DistortLUT[X], the following formulas 6 and 7 are satisfied in a step represented by S750.

Rbody=DistortLUT[X] (6)

Rpost=DistortLUT[X]−Rpre (7)

Then, in case that the vertical resolution is 480, the Ynew is compared with 479 in a step represented by S760. If the Ynew is the same as or smaller than 479, the following formula 8 is satisfied in a step represented by S770.

R(G,B)[Ynew]=(pix[Ynew−1]*Rpre+pix[Ynew]*Rbody+pix[Ynew+1] (8)

If the Ynew is 480, the following formula 9 is satisfied in a step represented by S780.

R(G,B)[Ynew]=(pix[Ynew−1]*Rpre+pix[Ynew]*Rbody) (9)

Accordingly, as described above, the gradation corresponding to a converted image coordinate value can be computed from a contracted image coordinate value.

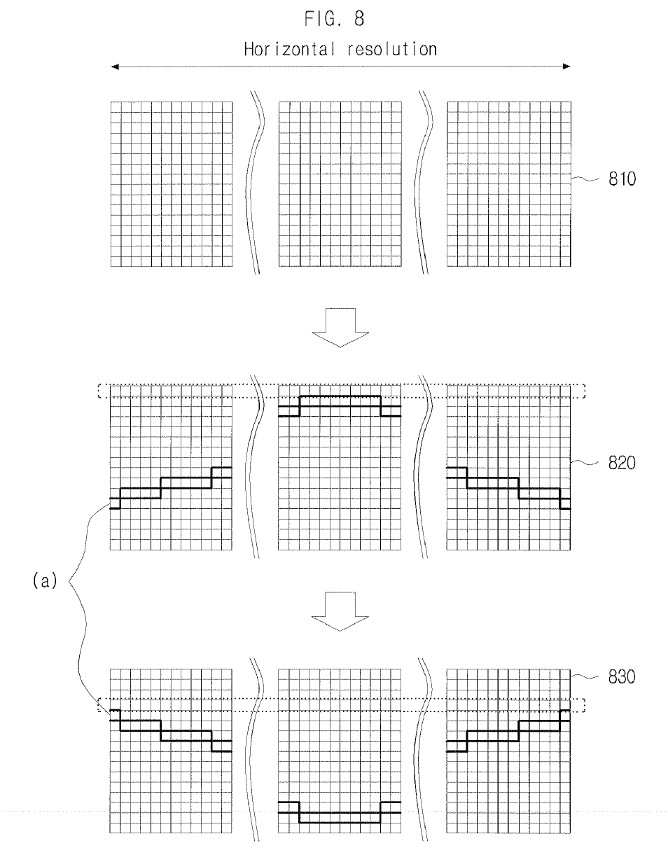

FIG. 8 is a data processing view illustrating a process of correcting a distorted image in accordance with an embodiment of the present invention.

A condition of starting to move from a buffer 810 having horizontal 16 lines corrected with the distortion to a buffer 820 having horizontal 16 lines for memory (e.g. SDR) storing can be satisfied when a new gradation is completed to be updated by distortion correction for all pixels of a 0^{th} horizontal 1-line buffer. In a distortion correcting buffer, which is a circular ring buffer, all pixels of a horizontal 1-line buffer is updated, and a little bit later, new correction data is updated from a center part or opposite end parts of a pertinent first line buffer again. The movement from the distortion correcting buffer to the buffer for memory storing can be started from the updating completion of every horizontal 1-line and stopped before the start of new updating.

In detail, the movement starts in case that a first value F is evaluated by delaying 3 lines from an inputted line, a second value S is evaluated by dividing the currently inputted Y number by 32, and the first value F is larger than the second value S (i.e. F−S >0). In other words, if at least horizontal 3 lines are stored in the horizontal 16-line buffer corrected with the distortion, the moving operation is started. When the transmittance of the last line is finished, the moving operation is in progress for the remaining several lines in accordance with the above-described computing method. All information of a horizontal N^{th} line, based on a converted image coordinate value after distortion correction, is written. Then, the information of the N^{th} line is moved to the horizontal 16-line buffer for SDR storing again.

In the case of a lower part of the converted image, when the last line on an inputted information basis is written, a middle-positioned line is being updated on a converted image coordinate value after distortion correction, due to the distortion. Accordingly, there may occur a demand requested to adjust the difference of line numbers of an original image coordinate value (i.e. inputted information) and a converted image coordinate value (i.e. outputted information).

The aforementioned image distortion correcting method in accordance with an embodiment of the present invention can be performed by storing data in a recorded medium and then coupling with a predetermined device, for example, an image processing device. Here, the recorded medium can be a magnetic or optical recoded medium, such as a hard disc, a video tape, a CD, a VCD and a DVD, or a database of a client or a server computer, on an on-line or off-line basis.

Although some embodiment of the present invention have been described, anyone of ordinary skill in the art to which the invention pertains should be able to understand that a very large number of permutations are possible without departing the spirit and scope of the present invention and its equivalents, which shall only be defined by the claims appended below.

What is claimed is:

1. A method by a display apparatus for correcting a distortion of an image by use of a diffractive optical modulator, the method comprising:
computing a contracted image coordinate value by multiplying an original image coordinate value by a contraction factor;
comparing the computed contracted image coordinate value with a converted image coordinate value;
extracting the contracted image coordinate value corresponding to the converted image coordinate value;
computing a gradation value of the converted image coordinate value from a gradation value of the contracted image coordinate value; and
operating the diffractive optical modulator in accordance with the computed gradation value of the converted image coordinate value.

2. The method of claim 1, wherein, in the step of computing the gradation value of the converted image coordinate value, if the converted image coordinate value is matched to 3 contracted image coordinate values, the gradation value of the converted image coordinate value is computed by a formula
L(Y)=l(Y−1)Rₚᵣₑ+l(Y)R_{body}+l(Y+1)Rₚₒₛₜ,
whereas L(Y) refers to the gradation of an Y^{th} coordinate value of a converted image; l(Y) refers to the gradation of an Y^{th} coordinate value of a contracted image; Rₚᵣₑ refers to a rate of a (Y−1)^{th} coordinate value of the contracted image, mapped to the Y^{th} coordinate value of the converted image; R_{body} refers to a rate of a (Y+1)^{th} coordinate value of the contracted image, mapped to the Y^{th} coordinate value of the converted image; and Rₚₒₛₜ refers to a rate of the (Y+1)^{th} coordinate value of the contracted image, mapped to the Y^{th} coordinate value of the converted image.

3. The method of claim 2, wherein the summation of the Rₚᵣₑ, the R_{body} and the Rₚₒₛₜ is equal to 1.

4. A display apparatus, comprising:
an image distortion removing unit, computing a contracted image coordinate value by multiplying an original image coordinate by a contraction factor, comparing the computed contracted image coordinate value with a converted image coordinate value, extracting the contracted image coordinate value corresponding to the converted image coordinate value, and computing a gradation value of the converted image coordinate value from a gradation value of the contracted image coordinate value;
an image processing unit, generating an image controlling signal corresponding to the gradation value of the converted image coordinate value, computed in the image distortion removing unit;
a driver IC, receiving the image controlling signal from the image processing unit and generating a driving voltage driving a diffractive optical modulator; and
the diffractive optical modulator, receiving the driving voltage from the driver IC and reflecting and refracting light incident from a light source.

5. The apparatus of claim 4, wherein, if the converted image coordinate value is matched to 3 contracted image coordinate values, the gradation value of the converted image coordinate value is computed by a following
L(Y)=l(Y−1)Rₚᵣₑ+l(Y)R_{body}+l(Y+1)Rₚₒₛₜ,
whereas L(Y) refers to the gradation of an Y^{th} coordinate value of a converted image; l(Y) refers to the gradation of an Y^{th} coordinate value of a contracted image; Rₚᵣₑ refers to a rate of a (Y−1)^{th} coordinate value of the contracted image, mapped to the Y^{th} coordinate value of the converted image; R_{body} refers to a rate of a (Y+1)^{th} coordinate value of the contracted image, mapped to the Y^{th} coordinate value of the converted image; and Rₚₒₛₜ refers to a rate of the (Y+1)^{th} coordinate value of the contracted image, mapped to the Y^{th} coordinate value of the converted image.

6. The apparatus of claim 5, wherein the summation of the Rₚᵣₑ, the R_{body} and the Rₚₒₛₜ is equal to 1.

7. The apparatus of claim 4, wherein the diffractive optical modulator comprises:
an upper reflective layer, being placed on a center part of a structural layer and reflecting and refracting the incident light;
a piezoelectric driving element, being placed on the structural layer and allowing the center part of the structural layer to move upwardly and downwardly; and
an optical reflective layer, being spaced away from the upper reflective layer and reflecting and refracting the incident light.
